(19) United States
(12) Patent Application Publication
(10) Pub. No.: US 2005/0259566 A1
(43) Pub. Date: Nov. 24, 2005

(54) Method and apparatus for transferring channel information in ofdm communications

(76) Inventors: Jae-Hak Chung, Seoul (KR); Yung-Soo Kim, Gyeonggi-do (KR); Eung-Sun Kim, Gyeonggi-do (KR)

Correspondence Address: Paul J Farrell;Dilworth & Barrese, 333 Earle Ovington Boulevard, Uniondale, NY, 11553, US

(21) Appl. No.: 10/489,376

(22) PCT Filed: Sep. 12, 2002
(86) PCT No.: PCT/KR02/01716

§ 371 Date: Mar. 12, 2004

(30) Foreign Application Priority Data
Sep. 12, 2001 (KR) 2001-56288
Sep. 11, 2002 (KR) 2002-54946

(51) Int. Cl. H04L 5/04

(52) U.S. Cl. 370/204; 370/210

(57) ABSTRACT

A method and apparatus for transferring channel information in OFDM communications are provided. In the channel information transmission apparatus, a receiving portion includes a prefix remover removing a prefix, attached to the OFDM signal in order to overcome channel fading, from an OFDM signal received from a transmission portion, a fast Fourier transformer transforming a received time domain signal from which the prefix has been removed into a frequency domain signal, a channel measurer extracting a channel value from the frequency region signal obtained by the fast Fourier transformer, a compensator compensating for the output signal of the fast Fourier transformer using the channel value obtained by the channel measurer, a parallel-to-serial converter converting a compensated parallel signal received from the compensator into a serial signal, and a signal processor processing the channel value measured by the channel measurer in order to transmit signal-processed data to the transmission portion.

### BACKGROUND OF THE INVENTION

This application claims the priority of Korean Patent Application Nos. 2001-56288 and 2002-54946, filed on Sep. 12, 2001 and Sep. 11, 2002, respectively, in the Korean Intellectual Property Office, the disclosures of which are incorporated herein in their entirety by reference.

1. Field of the Invention

The present invention relates to the field of communication systems adopting a frequency division transmission technique as an orthogonal frequency division multiplexing (OFDM) method, and more particularly, to a method in which a receiving portion measures channel information, compresses measured channel information, and transmits compressed data to a transmission portion, and a system for performing the method.

2. Description of the Related Art

An OFDM technique is widely used in digital communications, such as asymmetric digital subscriber line (ADSL), digital audio broadcasting (DAB), and digital video broadcasting (DVB), because it can easily remove interferences between symbols upon transmission.

When a transmitter of a communication system adopting an OFDM technique uses multiple antennas, the transmission speed can be improved by increasing the capacity of a channel. With such multiple antennas used, if data is transmitted under conditions in which transmission channel information is recognized, a transmission portion can transmit more data than when data is transmitted under conditions in which the transmission channel information is not recognized. Thus, the performance of transmission can be improved. The transmission performance can be improved by a multi-antenna system, singular value decomposition (SVD), beam forming, or a transmission diversity antenna selection method.

FIG. 1 is a block diagram of a transceiver adopting a conventional OFDM technique. In FIG. 1, signals are transmitted from the left side to the right side. A serial-to-parallel (S/P) converter 100a in a transmission portion converts a serial signal into a parallel signal so that the parallel signal is later processed using an inverse fast Fourier transform. A signal processing portion 100b process a signal before the parallel signal obtained by the S/P converter 100a is modulated. Here, the performance of transmission and reception can be improved by various methods, such as: SVD in the case that a transmission unit adopts a multi-antenna system; beam forming; and transmission diversity antenna selection. In the SVD technique, channel H can be decomposed into UAV^{H} by SVD. Hence, according to the SVD technique, the transmission performance of a transmitter depending on changes in channel can be improved by a transmission portion multiplexing eigenvectors U^{H} and a receiving portion 110 multiplexing eigenvectors V. Beam forming is a method capable of making a transmission signal having a strong directivity toward a receiving portion by multiplexing multi-antenna response vectors, which are obtained by a transmission channel in a transmission portion. In the beam forming method, the performance of transmission and reception is improved by increasing the intensity of a signal on a receiving terminal. Inverse Fast Fourier transform (IFFT) circuits 100c perform IFFT and correspond to a modulation portion for modulating an OFDM signal. In the IFFTs 100c, a signal is transformed from a frequency domain to a time domain. A parallel-to-serial (PS) converter 100d is a device for converting a signal transformed into a time region, which is a parallel signal, back into serial data. A cyclic prefix (CP) is added to data output from the P/S converter 100d in order to overcome channel fading. Final data is transmitted to a receiving terminal via transmission antennas 102. In FIG. 1, the number of transmission antennas 102 is N, i.e., Tx1, Tx2, . . . , and TxN, but one transmission antenna may be used. Channel paths 104 shown in FIG. 1 are channel paths installed between the transmission antennas 102 and receiving antennas 104. The receiving antennas 106 receive a signal transmitted via the channel paths 104. The number of receiving antennas 106 is M, i.e., Rx1, Rx2, . . . , and RxM, but one receiving antenna can be used like the transmission antenna 102. S/P converters 110a in the receiving portion 110 remove the CP from data received from the receiving antennas 106 and then convert the data from which the CP has been removed into parallel data. FFTs 110b serve as a demodulator for demodulating an OFDM signal and perform Fourier transform. A signal processing portion 110c corresponds to the signal processing portion 110b in the transmission portion 100. The signal processing portion 110c of the receiving portion 110 can include a channel measuring device. A P/S converter 110d converts parallel data into serial data.

As described above, when transceiving is performed by a conventional orthogonal frequency division multiplexing/frequency division duplexing (OFDM/FDD) technique, a transmission portion cannot measure transmission channels. Accordingly, if a transmission portion tries to increase the transmission: efficiency using a signal processing method, a receiving portion is required to send the information on measured channels to the transmission portion. However, in an existing OFDM/FDD system, a receiving portion sends channel information corresponding to each of sub-carriers of an OFDM signal when transmission the information on measured channel to a transmission portion. Accordingly, the number of transceiving antennas increases, leading to an increase in the amount of information to be transmitted. This may degrade the system performances.

### SUMMARY OF THE INVENTION

To solve the above-described problems, it is an object of the present invention to provide a channel information transmission apparatus in an orthogonal frequency division multiplexing/frequency division duplexing (OFDM/FDD) system, the apparatus in which, when channel information measured in a receiving portion is transmitted to a transmission portion, frequency domain information is transformed into time domain information, which is the length of a cyclic prefix (CP), the time domain information is compressed, and thereafter the compressed information is transmitted to the transmission portion. The transmission portion decodes the data received from the receiving portion to restore the channel information, thereby minimizing the loss of channel information to be transmitted to the transmission, portion and effectively reducing the amount of channel information to be transmitted.

Another object of the present invention is to provide a channel information transmission method using the transmission apparatus.

To achieve the object, the present invention provides a channel information transmission apparatus in an OFDM communication system, the apparatus including a receiving portion. In the receiving portion, a prefix remover removes a prefix from an OFDM signal received from a transmission portion for transmittirig an OFDM signal. A fast Fourier transformer transforms a received time domain signal from which the prefix has been removed into a frequency domain signal. A channel measurer measures a channel value from the frequency domain signal obtained by the fast Fourier transformer. A compensator compensates for the output signal of the fast Fourier transformer using the channel value obtained by the channel measurer. A parallel-to-serial converter converts a parallel signal compensated by the compensator into a serial signal. A signal processor processes the channel value measured by the channel measurer and transmits processed data to the transmission portion.

To achieve the above object, the present invention also provides a channel information transmission apparatus in an OFDM communication system, the apparatus including a transmission portion. In the transmission portion, a serial-to-parallel converter converts a received serial signal into a parallel signal. Before modulating the parallel signal output from the serial-to-parallel converter, a signal processor differently transforms the parallel signal according to the transmission purposes. An inverse fast Fourier transformer transforms a frequency domain signal obtained by the signal processor into a time domain signal. A parallel-to-serial converter converts the parallel time domain signal received from the inverse fast Fourier transformer into a serial signal. A cyclic prefix (CP) adder adds a CP to the serial signal received from the parallel-to-serial converter. A channel information receiver error-correction decodes and signal-processes a channel information signal compressed and fed back by a receiving portion.

In the channel information transmitting method performed in the receiving portion, first, a cyclic prefix is removed from a received time domain signal. Next, the received time domain signal from which the cyclic prefix has been removed is transformed into a frequency domain signal. Thereafter, a channel value is measured from the frequency domain signal. Then, output data that is obtained in step (b) is compensated for using the measured channel value. Next, the compensated data is converted into a serial signal. Then, the measured channel value is processed to turn into a suitable signal to be transmitted to a transmission portion.

To process the measure channel value, the measured channel value on the frequency domain is first transformed into a channel value on the time domain, and then the time domain channel value is compressed.

The time domain channel value is compressed using one of run length coding, zip coding, bit quantization coding, and arithmetic coding.

The compressed channel value is transformed into an error correction code and transmitted to the transmission portion.

The received time domain signal from which the cyclic prefix has been removed is transformed into a frequency domain signal using Fourier transformation.

The measured frequency domain channel value is transformed into a time domain channel value using a least square method.

In the channel information transmitting method performed in the transmission portion, first, a serial signal is converted into a parallel signal. Then, the parallel signal is processed. Thereafter, the processed parallel signal is transformed into a time domain signal. Next, the time domain parallel signal is converted into a serial signal. Then, a cyclic prefix is attached to the time domain serial signal. IN The transmission portion, a channel information signal compressed and received from a receiving portion is error correction decoded and processed to turn back into an original channel value measured in the receiving portion. The restored channel value is used in processing the parallel signal.

Here, the processed parallel signal is transformed into the time domain signal using an inverse Fourier transformation.

According to the present invention, if channel information is transmitted after being compressed, losses of channel information data can be minimized, and the number of channel information to be transmitted to a transmission portion can be reduced. Also, an up link channel can be effectively used. Furthermore, the data of a sending channel can be transmitted through the transmission of a small amount of data via a channel changing at any time. Thus, adaptability to a time change used in a transmission portion becomes relatively easy.

### BRIEF DESCRIPTION OF THE DRAWINGS

The above objects and advantages of the present invention will become more apparent by describing in detail a preferred embodiment thereof with reference to the attached drawings in which:

FIG. 1 is a block diagram of a transmission portion and a receiving portion in a conventional orthogonal frequency division multiplexing communication system;

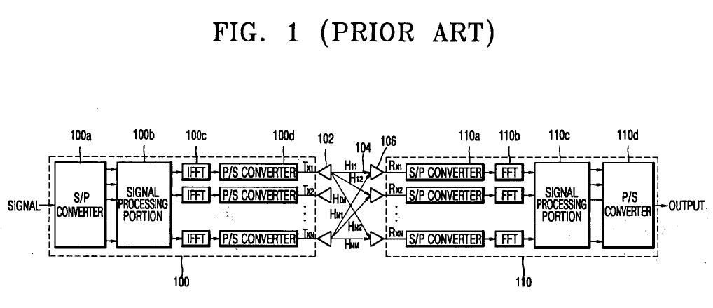

FIG. 2 is a block diagram of a receiving portion in an orthogonal frequency division multiplexing communication system according to the present invention; and

FIG. 3 is a block diagram of a transmission portion in an orthogonal frequency division multiplexing communication system according to the present invention.

### DETAILED DESCRIPTION OF THE INVENTION

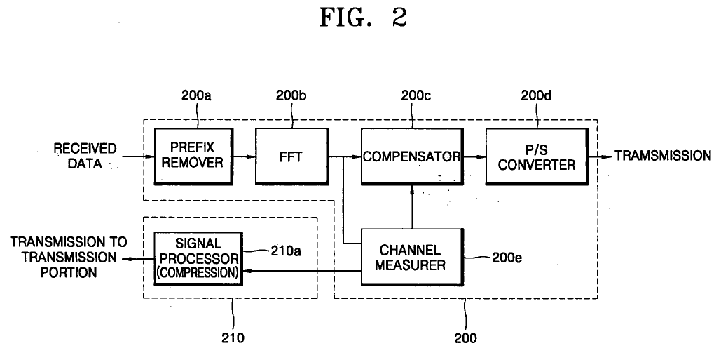

Referring to FIG. 2, a receiving portion in an orthogonal frequency division multiplexing (OFDM) communication system includes an OFDM receiver 200 and a channel information sender 210 for compressing received channel information and transmission compressed channel information to a transmission portion. The OFDM receiver 200 includes a prefix remover 200a, a fast Fourier transformer (FFT) 200b, a compensator 200c, a parallel-to-serial (P/S) converter 200d, and a channel measurer 200e. The prefix remover 200a removes a cyclic prefix from received data. The FFT 200b, which performs an OFDM demodulation, transforms the channel information of a time domain into the channel information of a frequency domain. The channel measurer 200e extracts a channel value from the fast Fourier transformed frequency domain channel information. Using the extracted channel value, the compensator 200c compensates for the output data of the FFT 200b. The P/S converter 200d converts a parallel signal output from the compensator 200c into a serial signal. The channel information sender 210 includes a signal processor 210a for compressing and processing a signal that is output from the channel measurer 200e in the OFDM receiver 200. If the signal processor 210a sends a channel value, that is, channel information extracted by the channel measurer 200e, in the frequency domain without change, data amount greatly increases by the number of OFDM subcarriers. Hence, it is preferable that the channel information of the frequency domain is converted into channel information of a time domain, the time domain channel information is compressed, and thereafter the resultant channel information is transmitted.

A method of compressing the channel information will now be described. In an OFDM, the length of a cyclic prefix (CP) is longer than that of a channel. In other words, CP information on the time domain includes all frequency information of the channel, and the length of the CP data on the time domain is shorter than that of a transmitted signal. Hence, if the channel information on the frequency domain is converted into the channel information on the time domain and then transmitted to a transmission portion, the amount of data transmitted to the transmission portion is reduced.

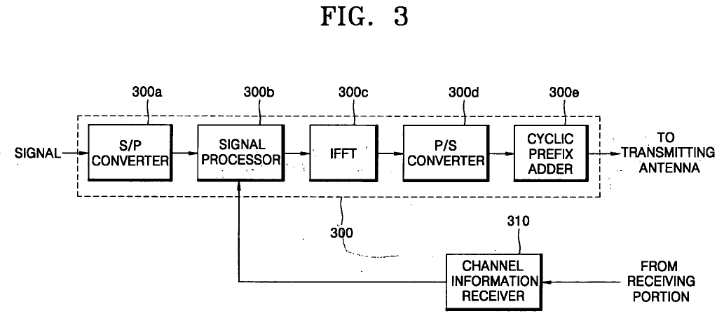

Inverse Fourier transform is used to convert the channel information on the frequency domain into the channel information on the time domain. However, an OFDM signal from a transmission portion sets a guard band for preventing transmission of a signal beyond a useable frequency band defined in propagation regulations, and a zero signal is sent to the guard band. Hence, if data received by a receiving portion is directly inverse Fourier transformed to convert channel information on the time domain into channel information on the frequency domain, all of exact channel information cannot be obtained. Accordingly, it is preferable that a least square method is used to effectively convert the channel information on the frequency domain into the channel information on the time domain. That is to say, time domain data h (n) minimizes the square of an error between Fourier-transformed frequency domain data included in a signal corresponding to the length of a CP in the time domain and frequency domain data obtained from a received signal. The time domain data h (n) is obtained using Equation 1:

$$min {\sum }_{m = 1}^{N} {\vert FET ( {h}^{′} ( n ) - H ( m ) ) \vert}^{2} \qquad ( 1 )$$

wherein N denotes the number of QFDM subcarriers, H(m) denotes the frequency domain channel information of an m-th subcarrier, and h (n) denotes time domain data to be desired. n denotes a time index in the time domain, and the value of n has the length of a CP. The time domain data h (n) undergoes either a general coding, such as, a run length coding, or a compression coding, such as an arithmetic coding, and then the resultant data is transmitted. Therefore, the amount of transmitted data is reduced. If the data is transformed into an error correction code and then transmitted to a transmission portion, transmission errors are minimized. The transmitted data is received by a channel information receiver 310 of FIG. 3 in the transmission portion and turns into channel information on the frequency domain through error correction decoding, compression decoding, and Fourier transformation. The time domain data h (n) is transmitted to the transmission portion.

To sum up, a channel information compression process during signal processing includes a step of converting channel information on the frequency domain into channel information on the time domain and a step of compressing and coding the converted data.

When the signal processor 210a compresses a channel value to be transmitted from the receiving portion to the transmission portion, any of a variety of methods, such as lossless coding or loss coding, can be taken. The lossless coding includes run length coding, zip coding, and the like, and the loss coding includes all kinds of region transformation coding techniques and consequent bit quantization and arithmetic coding. Such coded data is transformed into an error correction code and transmitted to the transmission portion.

FIG. 3 is a block diagram of a transmission portion in an orthogonal frequency division multiplexing communication system according to the present invention. The transmission portion includes an OFDM sender 300 and a channel information receiver 310 for signal-processing channel information compressed by and received from the receiving portion and sending a resultant signal to an OFDM signal processor 300b. The OFDM sender 300 includes an S/P converter 300a, the signal processor 300b, an IFFT 300c, a P/S converter 300d, and a cyclic prefix adder 300e. The S/P converter 300a converts received serial data into parallel data. The channel information receiver 310 error-correction decodes data received from the receiving portion and performs inverse signal-processing (decoding) on error-correction decoded data to restore it to a channel value measured in the receiving portion. Using data output from the channel information receiver 310, the signal processor 300b performs signal processing to improve the performance of transmission. The IFFT 300c, which corresponds to an OFDM modulator, transforms frequency domain data into time domain data using IFFT. The P/S converter 300d converts parallel data output from the IFFT 300c into serial data. The cyclic prefix adder 300e adds a cyclic prefix obtained from serial data obtained by the P/S converter 300d to the beginning of the serial data in order to overcome channel fading, and then transmits the serial data to which the cyclic prefix has been attached.

Channel information transmission performed in the above-described OFDM communication system will now be described. First, looking at channel information transmission performed in the receiving portion of FIG. 2, a CP attached in a transmission portion is removed from a received signal using the prefix remover 200a. The FFT 200b transforms the received time, domain signal from which the CP has been removed into a frequency domain signal. Thereafter, using the channel measurer 200e, a channel value is measured from the frequency data obtained by the FFT 200b. The compensator 200c compensates for the output data of the FFT 200b using the channel value measured by the channel measurer 200e. The P/S converter 200d converts the compensated data into a serial signal. Then, the signal processor 210a processes the channel value measured by the channel measurer 200e in order to change the channel value into a suitable form to be transmitted to the transmission portion of FIG. 3.

Then, looking at channel information transmission performed in the transmission portion of FIG. 3, the serial signal is converted into a parallel signal. Thereafter, the parallel signal is processed in the signal processor 300b before being modulated. Next, the processed signal on the frequency domain is transformed into a signal on the time domain, and the time domain parallel signal is then converted back into a serial signal. Then, a CP is attached to the time domain serial signal.

At this time, a signal restored to a channel value measured in the receiving portion is applied to the signal processor 300b. The restored signal is obtained by error-correction decoding and signal-processing the channel information signal that is compressed and fed back to the transmission portion.

When an OFDM communication system sends frequency channel information, the amount of channel information to be transmitted increases with an increase in the number of OFDM sub-carriers. Also, in case that multiple antennas are used, the amount of data to be transmitted increases with an increase in the number of antennas. However, compression and transmission of channel information according to the present invention can reduce the number of channel information to be transmitted to a transmission portion. Accordingly, an up link channel can be effectively used. Also, the data of a sending channel can be transmitted through the transmission of a small amount of data via a channel changing at any time. Thus, adaptability according to a time change can be relatively easily used in a transmission portion.

1. A channel information transmission apparatus in an orthogonal frequency division multiplexing (OFDM) communication system, the apparatus including a receiving portion comprising:
a prefix remover for removing a prefix from an OFDM signal received from a transmission portion for transmitting an OFDM signal;
a fast Fourier transformer for transforming a received time domain signal from which the prefix has been removed into a frequency domain signal;
a channel measurer for measuring a channel value from the frequency domain signal obtained by the fast Fourier transformer;
a compensator for compensating for the output signal of the fast Fourier transformer using the channel value obtained by the channel measurer;
a parallel-to-serial converter for converting a parallel signal compensated by the compensator into a serial signal; and
a signal processor for processing the channel value measured by the channel measurer and transmitting the processed channel value to the transmission portion, wherein the signal processor compresses the channel value to process the channel value.

2. The channel information transmission apparatus of claim 1, wherein the channel value is compressed by run length coding.

3. The channel information transmission apparatus of claim 1, wherein the channel value is compressed by zip coding.

4. The channel information transmission apparatus of claim 1, wherein the channel value is compressed by bit quantization.

5. The channel information transmission apparatus of claim 1, wherein the channel value is compressed by arithmetic coding.

6. The channel information transmission apparatus of claim 2, wherein the compressed channel value is transformed into an error correction code and transmitted to the transmission portion.

7. A channel information transmission apparatus in an OFDM communication system, the apparatus including a transmission portion comprising:
a serial-to-parallel converter for converting a received serial signal into a parallel signal;
a signal processor for processing the parallel signal output from the serial-to-parallel converter;
an inverse fast Fourier transformer for transforming a frequency domain signal obtained by the signal processor into a time domain signal;
a parallel-to-serial converter for converting the parallel time domain signal received from the inverse fast Fourier transformer into a serial signal;
a cyclic prefix (CP) adder for adding a CP to the serial signal received from the parallel-to-serial converter; and
a channel information receiver for error-correction decoding and signal-processing a channel information signal, which has been compressed in a receiving portion and fed back to the transmission portion, in order to restore the channel information signal to a channel value measured in the receiving portion, and sending the restored signal to the signal processor.

8. A channel information transmitting method performed in a receiving portion, comprising:
(a) removing a cyclic prefix from a received time domain signal;
(b) transforming the received time domain signal from which the cyclic prefix has been removed into a frequency domain signal;
(c) measuring a channel value from the frequency domain signal;
(d) compensating for output data, which is obtained in step (b), using the measured channel value;
(e) converting the compensated output data into a serial signal; and
(f) performing a signal processing to transmit the measured channel value to a transmission portion.

9. The channel information transmitting method of claim 8, wherein step (f) comprises:
transforming the measured channel value on the frequency domain into a channel value on the time domain; and
compressing the time domain channel value.

10. The channel information transmitting method of claim 9, wherein the time domain channel value is compressed using one of run length coding, zip coding, bit quantization coding, and arithmetic coding.

11. The channel information transmitting method of claim 9, wherein the compressed channel value is transformed into an error correction code and transmitted to the transmission portion.

12. The channel information transmitting method of claim 8, wherein the received time domain signal from which the cyclic prefix has been removed is transformed into a frequency domain signal using a Fourier transformer.

13. The channel information transmitting method of claim 9, wherein the measured frequency domain channel value is transformed into a time domain channel value using a least square method.

14. A channel information transmitting method performed in the transmission portion, comprising:
(a) converting a serial signal into a parallel signal;
(b) performing a signal processing on the parallel signal;
(c) transforming the processed parallel signal into a time domain signal;
(d) converting the time domain parallel signal into a serial signal; and
(e) attaching a cyclic prefix to the time domain serial signal,
wherein a signal restored to a channel value measured in a receiving portion is used in step (b), and the restored signal is obtained by error-correction decoding and processing a channel information signal that is compressed in the receiving and fed back to the transmission portion.

15. The channel information transmitting method of claim 14, wherein the signal-processed parallel signal is transformed into the time domain signal using an inverse Fourier transformer.

16. The channel information transmission apparatus of claim 3, wherein the compressed channel value is transformed into an error correction code and transmitted to the transmission portion.

17. The channel information transmission apparatus of claim 4, wherein the compressed channel value is transformed into an error correction code and transmitted to the transmission portion.

18. The channel information transmission apparatus of claim 5, wherein the compressed channel value is transformed into an error correction code and transmitted to the transmission portion.
